(19) United States
(12) Patent Application Publication
(10) Pub. No.: US 2026/0357732 A1
(43) Pub. Date: Nov. 12, 2026

(54) DEVICE FOR HEATING AN EXHAUST GAS FLOW WITH A TOLERANCE COMPENSATION

(71) Applicant: Schaeffler Technologies & Co. KG, Herzogenaurach (DE)

(72) Inventors: Ferdi KURTH, Mechemich (DE); Sven SCHEPERS, Troisdorf (DE); Alexander REGLIN, Siegburg (DE); Jan HODGSON, Troisdorf (DE)

(21) Appl. No.: 19/130,643

(22) PCT Filed: Nov. 16, 2023
(86) PCT No.: PCT/EP2023/082112

§ 371 Date: May 16, 2025

(30) Foreign Application Priority Data
Nov. 17, 2022 (DE) 10 2022 212 261.5

(51) Int. Cl. F01N 3/20

(52) U.S. Cl. CPC F01N 3/2013; F01N 2240/16; F01N 2450/22

(57) ABSTRACT

A device inserted into a housing of an exhaust gas line for heating an exhaust gas flow in an exhaust gas line, with an electrically heatable heating matrix and, a support structure connected to the heating matrix via a plurality of support pins. The heating matrix has flow channels through which exhaust gas flows in the main direction of flow from an end face forming the inflow side to an end face forming the outflow side. The support structure is designed in the form of a grid and is situated upstream and/or downstream of the heating matrix. The support pins which are plugged into the heating matrix and protrude from the inflow side and/or the outflow side are materially bonded to the support structure. The support structure has solder reservoirs, into which free ends of the support pins are plugged, on the surface facing the heating matrix.

### CROSS REFERENCE TO RELATED APPLICATIONS

This is a U.S. national stage of Application No. PCT/EP2023/082112 filed Nov. 16, 2023. Priority is claimed on German Application No. DE 10 2022 212 261.5 filed Nov. 17, 2022, the contents of which are incorporated herein by reference.

### BACKGROUND OF THE INVENTION

### 1. Field of the Invention

The disclsoure relates to a device for heating an exhaust gas flow in an exhaust gas line, with an electrically heatable heating matrix, with a support structure which is connected to the heating matrix via a plurality of support pins, wherein the device can be inserted into a housing of an exhaust gas line, wherein the heating matrix has a plurality of flow channels through which exhaust gas can flow in the main direction of flow from an end face forming the inflow side to an end face forming the outflow side, wherein the support structure is designed in the form of a grid and is situated upstream and/or downstream of the heating matrix, wherein the support pins which are plugged into the heating matrix and protrude from the inflow side and/or the outflow side are materially bonded to the support structure.

### 2. Description of the Related Art

Nowadays, electrical heating elements are often used to heat exhaust gases in an exhaust gas line downstream of an internal combustion engine, or the exhaust gas flowing in an exhaust gas line. The aim here is to more quickly reach a temperature threshold from which effective transformation of the pollutants entrained in the exhaust gas can take place. This is necessary because the catalytically active surfaces, used for exhaust gas aftertreatment, of the catalytic converters installed in the exhaust gas line only allow sufficient conversion of the respective pollutants from a minimum temperature, known as the light-off temperature.

The known solutions in the prior art include what are known as heated catalytic converters, which have a metallic structure connected to a voltage source or a metal-coated ceramic structure which can be heated by exploiting ohmic resistance.

The heatable metallic structures can consist, for example, of a honeycomb body produced from metal foils. To do this, a plurality of smooth and/or at least partially structured metal foils are stacked on top of one another and are wound about at least one pivot point to form a honeycomb body. The matrix formed from the metal foils can be electrically contacted and be heated by exploiting ohmic resistance.

For this purpose, the matrix must be arranged in an exhaust gas line and situated upstream or downstream, in the direction of flow of the exhaust gas, of a catalytic converter designed for exhaust gas aftertreatment.

In order to position the matrix in the exhaust gas line and to support it in particular against mechanical and thermal stresses, a bracket, a so-called support structure, must be pro-vided. The support structure must be formed so as to absorb the thermal alternating stresses and the high and irregular mechanical stresses in the exhaust gas line and to resist them. The support structure itself is fastened to the housing of the exhaust gas line.

In order to establish a materially bonded connection of the heating matrix to the support structure, so-called support pins are used which are plugged into cells of the heating matrix and connected to the support structure. All the components individually have certain manufacturing tolerances and furthermore further tolerances can be generated in the assembly process such that individual tolerances can add up to form negative tolerance chains and an unacceptable total tolerance exists which endangers the structural integrity of the component.

A disadvantage of the known solutions from the prior art is in particular that to date there are no suitable means that allow the connection of the support pins to the support structure to be constituted reliably, even when higher tolerances sometimes occur and the final position of the support pins relative to the support structure does not correspond to the actually planned position.

### SUMMARY OF THE INVENTION

An object of one aspect of the present invention is therefore to provide a device which is improved in such a way that the connections between the support structure and the support pins can also be reliably produced under the influence of large tolerances.

An exemplary aspect of the invention relates to a device for heating an exhaust gas flow in an exhaust gas line, with an electrically heatable heating matrix, with a support structure that is connected to the heating matrix via a plurality of support pins, wherein the device can be inserted into a housing of an exhaust gas line, wherein the heating matrix has a plurality of flow channels through which exhaust gas can flow in the main direction of flow from an end face forming the inflow side to an end face forming the outflow side, wherein the support structure is designed in the form of a grid and is situated upstream and/or downstream of the heating matrix, wherein the support pins which are plugged into the heating matrix and protrude from the inflow side and/or the outflow side are materially bonded to the support structure, wherein the support structure has solder reservoirs, into which the in each case free ends of the support pins are plugged, on the surface facing the heating matrix.

Production-related tolerances, which cannot be completely avoided, occur when manufacturing the individual parts of the device. During the assembly, the individual component tolerances can add up in a negative fashion such that sometimes large tolerances occur. In the case of the support pins, this can cause the support pins to project from the heating matrix by a different amount. Because the support structure is a substantially plane structure, the positional tolerances and component tolerances can mean that not all the support pins come to bear on the support structure. The formation of a durable materially bonded connection of the support pins to the support structure can be adversely affected as a result. In extreme cases, a faulty or non-existent connection occurs, as a result of which there can be loose support pins. This adversely affects the durability and the stability of the device and can in the worst-case scenario result in the destruction of the device.

According to one aspect of the invention, the support structure is formed with a plurality of solder reservoirs, wherein in each case one solder reservoir is associated with each support pin. The solder reservoirs serve as attachment regions for the support pins to the support structure.

It is particularly advantageous if the solder reservoirs are formed by depressions in the support structure. Positional tolerances of the support pins with respect to the support structure can be compensated by the solder reservoirs, formed as depressions, in the support structure. In an ideal embodiment of the device, the support pins all project from the heating matrix by the same amount such that the free ends of the support pins lie within a common plane. In reality, the free ends of most of the support pins lie in a certain random distribution slightly in front of or slightly behind this common plane.

In order to obtain an adequate connection of the support structure to the support pins, the support structure is positioned relative to the free ends of the support pins such that all the support pins project into the solder reservoir associated therewith by a predefined length. The depth of the solder reservoirs should therefore be selected such that a sufficient penetration depth into the solder reservoir is ensured for each of the support pins in order to be able to produce a soldered connection with a sufficient strength.

It is also advantageous if the support pins extend into the solder reservoirs. An adequate connection between the support pin and the support structure can be produced in the soldering process only by the projection of the free ends of the support pins into the solder reservoirs. Because of the positional tolerances of the support pins, the position of the respective free end of a support pin relative to the base of the associated solder reservoir of the support structure is different for each support pin. For an adequate connection, it must be ensured that a sufficient penetration depth is ensured also for the support pin furthest from the base of its solder reservoir.

A preferred exemplary embodiment is characterized in that the solder reservoirs have a clear opening width which is greater than the diameter of the support pins. By virtue of a clear opening width of the solder reservoirs which is greater than the diameter of the free ends of the support pins, in addition to compensating the positional tolerance in the direction which forms a surface normal to the plane of the support structure, a tolerance in both spatial directions of the plane of the support structure can also be achieved. The free end of the support pin does not have to be arranged precisely in the center of the solder reservoir in the finally assembled state and instead can also be arranged offset thereto.

It is also preferred if the solder reservoirs are introduced into the support structure by machining. In particular, the formation of the solder reservoirs by blind holes is advantageous. It is furthermore advantageous if the solder reservoirs are produced by reshaping the support structure. For example, the solder reservoirs can be produced by being embossed into the support structure.

It is furthermore advantageous if the solder reservoirs are filled with soldering paste and/or soldering powder. The prefilled solder reservoirs can be simply melted in a subsequent soldering process in order to produce a materially bonded connection to the support pins engaging in the solder reservoirs.

It is also expedient if at least a first number of support pins bear in the finally assembled state on the base of their respective solder reservoir. Depending on the available insertion depth of the solder reservoirs compared with the respective positional tolerances of the support pins, in the finally assembled state a certain number of the support pins will bear directly against the base region of the solder reservoir with their free ends.

Advantageous developments of the present invention are described in the dependent claims and in the description of the figures that follows.

### BRIEF DESCRIPTION OF THE DRAWINGS

The invention is explained in detail below on the basis of exemplary embodiments with reference to the drawings, in which:

FIG. 1 is a view in section through a heating matrix with a plugged-in support pin, wherein the support pins engage in solder reservoirs of the support structure situated upstream and downstream; and

FIGS. 2A and 2B are views in section through in each case one support structure with solder reservoirs.

### DETAILED DESCRIPTION OF THE PRESENTLY PREFERRED EMBODIMENTS

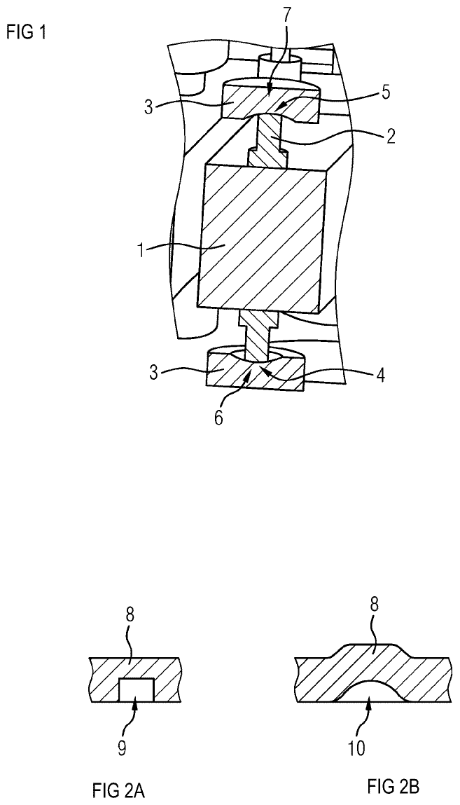

FIG. 1 shows a view in section through a heating matrix 1 from which a support pin 2 protrudes on both sides. A support structure 3 is arranged upstream and downstream of the heating matrix 1. The in each case free ends 4, 5 of the support pin 2 project into solder reservoirs 6, 7 which are formed in the support structure 3. The solder material with which the solder reservoirs 6, 7 are filled is melted by a soldering process and a connection is permanently established to the support pins 2 projecting into the solder reservoirs 6, 7 and to the support structure 3.

FIGS. 2A and 2B show a view in section through a support structure 8, wherein a solder reservoir 9 which has been produced by machining is shown in FIG. 2A. A solder reservoir 10 which is produced by a reshaping process, for example embossing, is shown in FIG. 2B.

The exemplary embodiments of FIGS. 1 to 2 in particular have no limiting character and serve to illustrate the concept of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A device configured to be inserted into a housing of an exhaust gas line for heating an exhaust gas flow in an exhaust gas line, comprising:
an electrically heatable heating matrix having a plurality of flow channels through which exhaust gas can flow in a main direction of flow from an end face forming an inflow side to an end face forming an outflow side;
a plurality of support pins;
a support structure designed as a grid and connected to the heating matrix via the plurality of support pins, support structure situated upstream and/or downstream of the heating matrix,
wherein the plurality of support pins are plugged into the heating matrix and protrude from the inflow side and/or the outflow side are materially bonded to the support structure,
wherein the support structure has solder reservoirs, into which, in each case, free ends of the plurality of support pins are plugged, on a surface facing the heating matrix.

10. The device as claimed in claim 9, wherein the solder reservoirs are formed by depressions in the support structure.

11. The device as claimed in claim 9, wherein the plurality of support pins extend into the solder reservoirs.

12. The device as claimed in claim 9, wherein the solder reservoirs have a clear opening width which is greater than a diameter of the plurality of support pins.

13. The device as claimed in claim 9, wherein the solder reservoirs are introduced into the support structure by machining.

14. The device as claimed in claim 9, wherein the solder reservoirs are produced by reshaping of the support structure.

15. The device as claimed in claim 9, wherein the solder reservoirs are filled with soldering paste and/or soldering powder.

16. The device as claimed in claim 9, wherein at least a first number of the plurality of support pins bear against a base of their respective solder reservoir in a finally assembled state.
